(19) United States
(12) Patent Application Publication
(10) Pub. No.: US 2025/0001341 A1
(43) Pub. Date: Jan. 2, 2025

(54) MAGNETIC COVER FOR AIR FILTER BOX

(71) Applicant: K&N Engineering, Inc., Riverside, CA (US)

(72) Inventors: Gilbert Heck, Riverside, CA (US); Patrick Gallagher, Riverside, CA (US); Steve Williams, Cherry Valley, CA (US)

(73) Assignee: K&N Engineering, Inc., Riverside, CA (US)

(21) Appl. No.: 18/217,306

(22) Filed: Jun. 30, 2023

(51) Int. Cl. B01D 46/00; B01D 46/24

(52) U.S. Cl. CPC B01D 46/0005; B01D 46/24; B01D 2265/023; B01D 2275/201; B01D 2279/60

(57) ABSTRACT

An apparatus and methods are provided for a magnetic cover for an air filtration system for an internal combustion engine. The air filtration system includes a housing that has an interior that receives an air filter. A mount portion comprising the housing supports the air filter. The magnetic cover encloses the interior of the housing. An edge portion surrounding an opening in the housing forms an airtight connection with an edge portion of the magnetic cover. The edge portion of the housing includes a number of magnets that attach to a similar number of magnets in the edge portion of the magnetic cover to establish the airtight connection. A seal provides an airtight connection between the housing and the magnetic cover. The housing and the magnetic cover are configured for hand removal of the magnetic cover from the housing.

### FIELD

Embodiments of the present disclosure generally relate to filtration devices. More specifically, embodiments of the disclosure relate to an apparatus and methods for a magnetic cover for an air filtration system for an internal combustion engine.

### BACKGROUND

An air filter designed to remove particulate is generally a device composed of fibrous materials. These fibrous materials may remove solid particulates such as dust, pollen, mold, and bacteria from the air. Air filters are used in applications where air quality is important, notably in building ventilation systems and with engines.

Air filters may be used in automobiles, trucks, tractors, locomotives, and other vehicles that use internal combustion engines. Air filters may be used with gasoline engines, diesel engines, or other engines that run on fossil fuels or other combustible substances. Air filters may be used with engines in which combustion is intermittent, such as four-stroke and two-stroke piston engines, as well as other types of engines that take in air so that a combustible substance may be burned. For example, air filters may be used with some gas turbines. Filters may also be used with air compressors or in other devices that take in air.

Filters may be made from pleated paper, foam, cotton, spun fiberglass, or other known filter materials. Generally, the air intakes of internal combustion engines and compressors tend to use paper, foam, or cotton filters. Some filters use an oil bath. Air filters for internal combustion engines prevent abrasive particulate matter from entering the combustion cylinders of the engine, wherein the particulate matter would cause mechanical wear and oil contamination. Many fuel injected engines utilize a flat panel, pleated paper filter element. This filter usually is placed inside an enclosed, plastic air box connected to a throttle body by way of ductwork. Vehicles that use carburetors or throttle body fuel injection systems typically use a cylindrical air filter positioned above the carburetor or the throttle body.

A drawback to conventional enclosed air boxes that utilize flat panel paper filters is that as particular matter builds up in the filter, air flow through the filter becomes restricted. Such a restricted air flow generally leads to a reduction in engine performance, such as a decrease in engine power output and greater fuel consumption. Moreover, as the paper filter becomes increasingly clogged, pressure below the filter decreases while the atmospheric air pressure outside the filter remains the same. When the difference in pressure becomes too great, contaminants may be drawn through the paper filter directly into the engine. Thus, the ability of the paper filter to protect the engine from contamination and internal damage tends to decrease near the end of the filter's service life. Typically, paper air filters are removed from the vehicle and discarded, and a new paper air filter is then installed. Considering that there are millions of vehicles throughout the world, the volume of discarded air filters that could be eliminated from landfills is a staggering number.

Many current air filters are of a reusable variety that enables a practitioner to periodically clean the air filter and reuse it rather than discarding the entire air filter, as is done with conventional air filters. In general, such a reusable air filter must be removed from an air filter box housing the air filter before the filter may be cleaned. Often, removing the air filter requires removing air ducting that is coupled with the air filter box before the air filter box can be opened to extract the air filter. Once cleaned, the air filter must be reinstalled into the air filter box before the air filter box may be closed and any air ducting recoupled with the air filter box. As will be appreciated, many practitioners may conclude that cleaning the air filter is too complicated, thereby discouraging widespread adoption of reusable air filters. What is needed, therefore, is an air filtration system that simplifies removing and reinstalling an air filter.

### SUMMARY

An apparatus and methods are provided for a magnetic cover for an air filtration system for an internal combustion engine. The air filtration system includes a housing that has an interior configured to receive an air filter. A mount portion comprising the housing is configured to support the air filter. The magnetic cover encloses the interior of the housing. An edge portion surrounding an opening in the housing is configured to form an airtight connection with an edge portion of the magnetic cover. The edge portion of the housing includes a number of magnets that attach to a similar number of magnets disposed along the edge portion of the magnetic cover so as to establish the airtight connection. A seal disposed between the edge portion of the housing and the edge portion of the magnetic cover provides the airtight connection between the edge portion and the magnetic cover. The housing and the magnetic cover are configured to facilitate a practitioner using a hand to remove the magnetic cover from the housing.

In an exemplary embodiment, an air filtration system for an internal combustion engine comprises: a housing comprising an air filter box having an interior configured to receive an air filter; a mount portion configured to support the air filter; a magnetic cover to enclose the interior; and an inlet to allow an airstream to enter the interior.

In another exemplary embodiment, the housing includes an opening configured to provide access to the air filter within the interior. In another exemplary embodiment, an edge portion surrounding the opening is configured to form an airtight connection with an edge portion of the magnetic cover. In another exemplary embodiment, a seal is configured to be disposed between the edge portion and the edge portion of the magnetic cover. In another exemplary embodiment, the seal is configured to provide an airtight connection of the edge portion and the edge portion of the magnetic cover.

In another exemplary embodiment, the edge portion includes a first plurality of magnets configured to attach to a second plurality of magnets that are disposed along the edge portion of the magnetic cover so as to establish the airtight connection. In another exemplary embodiment, one or more of the first plurality of magnets and the second plurality of magnets comprises Neodymium magnets. In another exemplary embodiment, the first plurality of magnets and the second plurality of magnets each comprises four magnets. In another exemplary embodiment, the magnetic cover comprises a magnetic material configured to attach to the first plurality of magnets.

In another exemplary embodiment, the housing includes at least one depression configured to facilitate a practitioner using a hand to remove the magnetic cover from the housing. In another exemplary embodiment, the at least one depression comprises a first depression and a second depression disposed near opposite sides of the magnetic cover. In another exemplary embodiment, the housing comprises a plurality of structural supports configured to increase the rigidity of the housing to withstand stresses arising during pulling the magnetic cover from the housing. In another exemplary embodiment, the plurality of structural supports comprises a plurality of ribs disposed near one or more of the first depression and the second depression.

In another exemplary embodiment, the mount portion is configured to establish an airtight connection with a base of the air filter. In another exemplary embodiment, the mount portion is configured to receive a seal comprising the base. In another exemplary embodiment, the mount portion includes threaded holes to receive fasteners for coupling the base to the mount portion.

In another exemplary embodiment, the inlet is configured to receive a conduit comprising the internal combustion engine. In another exemplary embodiment, the inlet is configured to allow an airstream to exit the conduit and enter the interior of the housing. In another exemplary embodiment, the inlet includes a flange for receiving the conduit. In another exemplary embodiment, the flange includes a cross-sectional shape and size for receiving interior of the conduit. In another exemplary embodiment, the flange includes any one or more of ridges, raised portions, lips, and other surface features configured to engage with the conduit.

In another exemplary embodiment, the magnetic cover comprises a rigid material that is sufficiently durable and temperature resistant to retain its configuration during installation and operation when coupled with the housing. In another exemplary embodiment, the magnetic cover comprises an injection molded material and a plurality of magnets disposed along an edge portion of the magnetic cover so as to attach to a plurality of magnets disposed along an edge portion surrounding an opening to the interior of the housing. In another exemplary embodiment, the magnetic cover comprises a metallic material that is capable of magnetically attaching to a plurality of magnets disposed along an edge portion surrounding the opening to the interior of the housing. In another exemplary embodiment, the metallic material includes a thermal coating to provide heat resistance properties to the magnetic cover. In another exemplary embodiment, the magnetic cover comprises a shape and a size that are adapted to engage with the edge portion surrounding the opening to the interior of the housing.

In an exemplary embodiment, a method for an air filtration system for an internal combustion engine comprises: forming a housing comprising an air filter box having an interior configured to receive an air filter; configuring a mount portion to support the air filter; forming a magnetic cover to enclose the interior; and disposing an inlet to allow an airstream to enter the interior.

In another exemplary embodiment, forming the housing includes configuring an opening to provide access to the air filter within the interior. In another exemplary embodiment, configuring the opening includes configuring an edge portion surrounding the opening to form an airtight connection with an edge portion of the magnetic cover. In another exemplary embodiment, configuring the edge portion includes disposing a first plurality of magnets along the edge portion to attach to a second plurality of magnets that are disposed along the edge portion of the magnetic cover so as to establish the airtight connection.

In another exemplary embodiment, forming the housing includes configuring at least one depression to facilitate a practitioner using a hand to remove the magnetic cover from the housing. In another exemplary embodiment, configuring the at least one depression comprises disposing a first depression and a second depression near opposite sides of the magnetic cover. In another exemplary embodiment, forming the housing comprises configuring a plurality of structural supports to increase the rigidity of the housing to withstand stresses arising during the practitioner pulling the magnetic cover from the housing. In another exemplary embodiment, configuring the plurality of structural supports comprises disposing a plurality of ribs near one or more of the first depression and the second depression.

In another exemplary embodiment, configuring the mount portion comprises configuring the mount portion to establish an airtight connection with a base of the air filter. In another exemplary embodiment, configuring the mount portion comprises configuring the mount portion to receive a seal comprising the base. In another exemplary embodiment, configuring the mount portion includes forming threaded holes to receive fasteners for coupling the base to the mount portion.

In another exemplary embodiment, disposing the inlet comprises configuring the inlet to receive a conduit comprising the internal combustion engine so as to allow an airstream to exit the conduit and enter the interior of the housing. In another exemplary embodiment, configuring the inlet includes configuring a flange that has a cross-sectional shape and size for receiving an interior of the conduit. In another exemplary embodiment, configuring the flange includes incorporating into the flange any one or more of ridges, raised portions, lips, and other surface features to engage with the conduit.

In another exemplary embodiment, forming the magnetic cover comprises forming a rigid material that is sufficiently durable and temperature resistant to retain its configuration during installation and operation when coupled with the housing. In another exemplary embodiment, forming the magnetic cover comprises injection molding a material into and disposing a plurality of magnets along an edge portion of the magnetic cover so as to attach to a plurality of magnets disposed along an edge portion surrounding an opening to the interior of the housing. In another exemplary embodiment, forming the magnetic cover comprises fabricating a metallic material that is capable of magnetically attaching to a plurality of magnets disposed along an edge portion surrounding the opening to the interior of the housing. In another exemplary embodiment, fabricating the metallic material includes applying a thermal coating to provide heat resistance properties to the magnetic cover. In another exemplary embodiment, forming the magnetic cover comprises adapting a shape and a size to engage with the edge portion surrounding the opening to the interior of the housing.

These and other features of the concepts provided herein may be better understood with reference to the drawings, description, and appended claims.

### BRIEF DESCRIPTION OF THE DRAWINGS

The drawings refer to embodiments of the present disclosure in which:

FIG. 1 illustrates an isometric view of an exemplary embodiment of an air filtration system comprising an air filter box and a magnetic cover to enclose the air filter box, according to the present disclosure;

FIG. 2 is a close-up detail view of FIG. 1, illustrating magnets disposed between the magnetic cover and the air filter box in accordance with the present disclosure; and

FIG. 3 is a flow chart illustrating an exemplary embodiment of a method for configuring an air filtration system comprising an air filter box and a magnetic cover to enclose the air filter box, according to the present disclosure.

While the present disclosure is subject to various modifications and alternative forms, specific embodiments thereof have been shown by way of example in the drawings and will herein be described in detail. The present disclosure should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the air filtration system and methods disclosed herein may be practiced without these specific details. In other instances, specific numeric references such as “first air filter,” may be made. However, the specific numeric reference should not be interpreted as a literal sequential order but rather interpreted that the “first air filter” is different than a “second air filter.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

Many current air filters are of a reusable variety that enables a practitioner to periodically clean the air filter and reuse it rather than discarding the entire air filter, as is done with conventional air filters. In general, such a reusable air filter must be removed from an air filter box housing the air filter before the filter may be cleaned. Often, removing the air filter requires removing air ducting that is coupled with the air filter box before the air filter box can be opened to extract the air filter. Once cleaned, the air filter must be reinstalled into the air filter box before the air filter box may be closed and any air ducting recoupled with the air filter box. As will be appreciated, many practitioners may conclude that cleaning the air filter is too complicated, thereby discouraging widespread adoption of reusable air filters. Embodiments presented herein provide an apparatus and methods for an air filtration system that includes a magnetic cover that simplifies removing and reinstalling an air filter for an internal combustion engine.

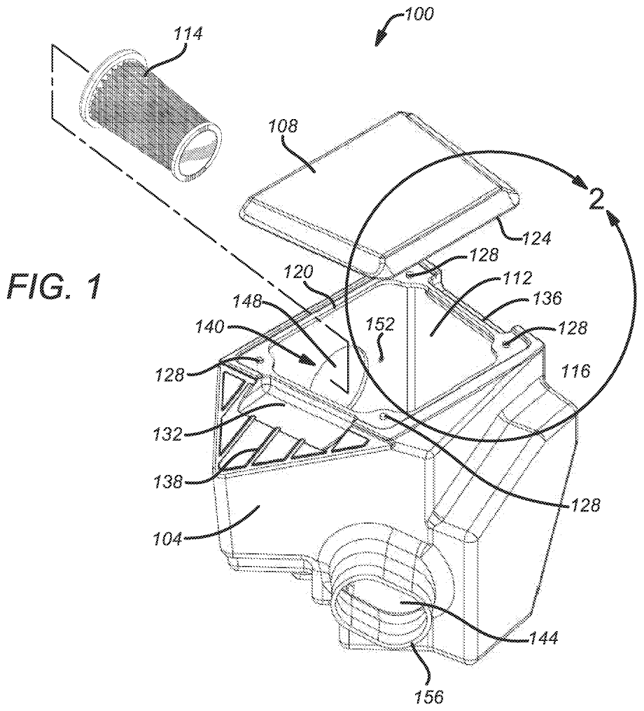

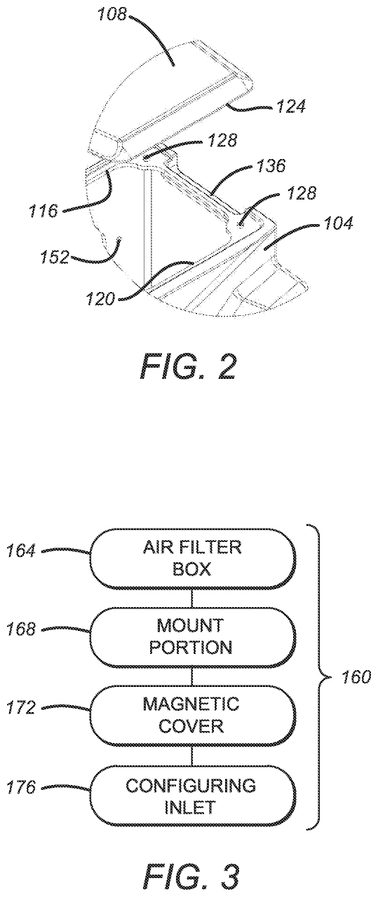

FIG. 1 illustrates an exemplary embodiment of an air filtration system 100 comprising an air filter box 104 and a magnetic cover 108 to enclose the air filter box 104, according to the present disclosure. The air filter box comprises a housing 104 having an interior 112 configured to receive an air filter 114. The air filter 114 may generally be of a cone-shaped variety of air filter as shown in FIG. 1, but it should be borne in mind that the embodiments disclosed herein are not limited to cone-shaped air filters. Rather, the housing 104 may be configured to receive any of a wide variety of generally enclosed air filter shapes, such as cylindrical, circular, oval, round, curved, conical, or any other closed perimeter shape, that provide a relatively large surface area in a given volume of the filter. Moreover, embodiments as described herein are not limited to use with internal combustion engines, but rather the air filtration system 100 may have applicability in other filtration systems in which a large volume of air requires treatment.

As shown in FIG. 1, the housing 104 includes an opening 116 configured to provide access to the air filter 114 within the interior 112. An edge portion 120 surrounding the opening 116 is configured to form an airtight connection with an edge portion 124 of the magnetic cover 108. Further, a seal (not shown) may be disposed between the edge portion 120 and the edge portion 124 of the magnetic cover 108. As will be appreciated, the seal may be configured to provide an airtight connection between the edge portions 120, 124. In some embodiments, the seal may be incorporated into either of the edge portions 120, 124, without limitation.

With continuing reference to FIG. 1, the edge portion 120 includes a first plurality of magnets 128 configured to attach to a second plurality of magnets that are disposed along the edge portion 124 of the magnetic cover 108 so as to establish an airtight connection between the housing 104 and the magnetic cover 108. In the illustrated embodiment, the first plurality of magnets 128 and the second plurality of magnets (not shown) each comprises four magnets. It should be understood, however, that the first plurality of magnets 128 and the second plurality of magnets may comprise any number of magnets, without limitation. In some embodiments, for example, at least a portion of the magnetic cover 108 may comprise a magnetic material configured to attach to the first plurality of magnets 128. Further, it is contemplated that the first plurality of magnets 128 and the second plurality of magnets may comprise any suitable magnetic material, without limitation. In some embodiments, for example, one or more of the first plurality of magnets 128 and the second plurality of magnets comprises Neodymium magnets.

The magnetic cover 108 generally comprises a rigid material that is sufficiently durable and temperature resistant to retain its configuration during installation and operation when coupled with the housing 104. Further, the magnetic cover 108 generally includes a shape and a size that are adapted to engage with the edge portion 120 surrounding the opening 116 to the interior 112 of the housing 104. In some embodiments, the magnetic cover 108 comprises an injection molded material, such as plastic, ABS, or other suitable material. Further, the first plurality of magnets (not shown) may be molded into or adhered along the edge portion 124 of the magnetic cover 108 so as to attach to the plurality of magnets 128 disposed along the edge portion 120 of the housing 104. In some embodiments, however, the magnetic cover 108 may comprise a metallic material that is capable of magnetically attaching to the first plurality of magnets 128 disposed along the edge portion 120 of the housing 104. It is contemplated that, in such embodiments, the metallic material may include a thermal coating to provide heat resistance properties to the magnetic cover 108.

In the illustrated embodiment of FIG. 1, the housing 104 includes a first depression 132 and a second depression 136 disposed near opposite sides of the opening 116. The depressions 132, 136 are configured to facilitate a practitioner using hands to remove the magnetic cover 108 from the housing 104. It is contemplated, however, that the housing is not limited to including two depressions 132, 136, but rather any number of depressions may be incorporated into the housing 104, near the opening 116. For example, in some embodiments, the housing 104 may include only one depression 132 to enable the practitioner to use one hand to lift the magnetic cover 108 from the housing 104.

Moreover, in some embodiments, the housing 104 may include a plurality of structural supports configured to increase the rigidity of the housing 104. It is contemplated that the structural supports may be configured such that the housing 104 is capable of withstanding stresses arising during the practitioner pulling the magnetic cover 108 off the opening 116. As shown in FIG. 1, the plurality of structural supports may comprise a plurality of ribs 138 disposed near one or both of the first depression 132 and the second depression 136.

As shown in FIG. 1, the housing 104 includes a mount portion 140 and an inlet 144. The mount portion 140 is configured to establish an airtight connection with the air filter 114. As will be appreciated, the mount portion 140 comprises an opening 148 that serves to direct a filtered airstream from an interior of the air filter 114 to an air intake of the internal combustion engine. It is contemplated that the mount portion 140 surrounding the opening 148 may be configured to receive a seal (not shown) comprising a base of the air filter 114. For example, the mount portion 140 may include threaded holes 152 to receive fasteners for coupling the base of air filter 114 to the mount portion 140, such that the interior of the air filter 114 is in fluid communication with the opening 148. Further details regarding coupling the base of air filter 114 to the mount portion 140 can be found in U.S. Pat. No. 11,478,739 B2, entitled “Flangeless Air Filter,” Granted Oct. 25, 2022, the entirety of which is incorporated herein by reference.

With continuing reference to FIG. 1, the inlet 144 is configured to receive a conduit (not shown) comprising the internal combustion engine. The inlet 144 generally is configured to allow an inflowing airstream to exit the conduit and enter the interior 112 of the housing 104. In the illustrated embodiment, the inlet 144 comprises a flange 156 for receiving the conduit. The flange 156 includes a cross-sectional shape and size for receiving interior of the conduit. It is contemplated that the flange 156 may include any one or more of ridges, raised portions, lips, and other surface features configured to engage with the conduit, without limitation.

FIG. 3 is a flow chart illustrating an exemplary embodiment of a method 160 for configuring an air filtration system 100 comprising an air filter box 104 and a magnetic cover 108 to enclose the air filter box, according to the present disclosure. The method 160 begins with step 164, which includes forming a housing 104 comprising an air filter box having an interior 112 configured to receive an air filter 114 (see FIG. 1). In some embodiments, forming the housing 104 includes configuring an opening 116 to provide access to the air filter 114 within the interior 112. Step 164 may include, in some embodiments, configuring an edge portion 120 surrounding the opening 116 to form an airtight connection with an edge portion 124 of the magnetic cover 108. Further, configuring the edge portion 120 may include, in some embodiments, disposing a first plurality of magnets 128 along the edge portion 120 to attach to a second plurality of magnets disposed along the edge portion 124 of the magnetic cover 108 so as to establish the airtight connection.

Moreover, step 164 may include, in some embodiments, configuring at least one depression 132 on the housing 104 to facilitate a practitioner using a hand to remove the magnetic cover 108 from the housing 108. In some embodiments, configuring the at least one depression comprises disposing a first depression 132 and a second depression 136 near opposite sides of the magnetic cover 108. Further, in some embodiments, forming the housing 104 comprises configuring a plurality of structural supports to increase the rigidity of the housing 104 to withstand stresses arising during the practitioner pulling the magnetic cover 108 from the housing 104. In some embodiments, configuring the plurality of structural supports comprises disposing a plurality of ribs 138 near one or more of the first depression 132 and the second depression 136.

Step 168 may, in some embodiments, comprise configuring a mount portion 140 to support the air filter 114. In some embodiments, configuring the mount portion 140 comprises configuring the mount portion 140 to establish an airtight connection with a base of the air filter 114. Further, step 168 may include, in some embodiments, configuring the mount portion 140 to receive a seal comprising the base. In some embodiments, configuring the mount portion 140 may include forming threaded holes 152 to receive fasteners for coupling the base to the mount portion 140.

As shown in FIG. 3, step 172 of method 160 may include forming the magnetic cover 108 to enclose the interior 112 of the housing 104. Forming the magnetic cover 108 may, in some embodiments, comprise forming a rigid material that is sufficiently durable and temperature resistant to retain its configuration during installation and operation when coupled with the housing 104. Further, forming the magnetic cover 108 comprises adapting a shape and a size to engage with the edge portion 120 surrounding the opening 116 to the interior 112 of the housing 104.

In some embodiments, forming the magnetic cover 108 comprises injection molding a material into and disposing a plurality of magnets along the edge portion 124 of the magnetic cover 108 so as to attach to the plurality of magnets 128 disposed along the edge portion 120 surrounding the opening 116 to the interior 112 of the housing 104. In some embodiments, however, forming the magnetic cover 108 comprises fabricating a metallic material that is capable of magnetically attaching to the plurality of magnets 128 disposed along the edge portion 120 surrounding the opening 116 to the interior 112 of the housing 104. Fabricating the metallic material may include, in some embodiments, applying a thermal coating to provide heat resistance properties to the magnetic cover 108.

Step 176 of method 160 comprises, in some embodiments, disposing an inlet 144 to allow an airstream to enter the interior 112. Disposing the inlet may, in some embodiments, comprise configuring the inlet 144 to receive a conduit comprising the internal combustion engine so as to allow the airstream to exit the conduit and enter the interior 112 of the housing 104. Configuring the inlet 144 includes, in some embodiments, configuring a flange 156 that has a cross-sectional shape and size for receiving an interior of the conduit. In some embodiments, configuring the flange 156 includes incorporating into the flange 156 any one or more of ridges, raised portions, lips, and other surface features to engage with the conduit.

While the air filtration system and methods have been described in terms of particular variations and illustrative figures, those of ordinary skill in the art will recognize that the air filtration system is not limited to the variations or figures described. In addition, where methods and steps described above indicate certain events occurring in certain order, those of ordinary skill in the art will recognize that the ordering of certain steps may be modified and that such modifications are in accordance with the variations of the air filtration system. Additionally, certain of the steps may be performed concurrently in a parallel process, when possible, as well as performed sequentially as described above. To the extent there are variations of the air filtration system, which are within the spirit of the disclosure or equivalent to the air filtration system found in the claims, it is the intent that this patent will cover those variations as well. Therefore, the present disclosure is to be understood as not limited by the specific embodiments described herein, but only by scope of the appended claims.

What is claimed is:

1. An air filtration system for an internal combustion engine, the system comprising:
a housing comprising an air filter box having an interior configured to receive an air filter;
a mount portion configured to support the air filter;
a magnetic cover to enclose the interior; and
an inlet to allow an airstream to enter the interior.

2. The system of claim 1, wherein the housing includes an opening configured to provide access to the air filter within the interior.

3. The system of claim 2, wherein an edge portion surrounding the opening is configured to form an airtight connection with an edge portion of the magnetic cover.

4. The system of claim 2, wherein a seal is configured to be disposed between the edge portion and the edge portion of the magnetic cover.

5. The system of claim 4, wherein the edge portion includes a first plurality of magnets configured to attach to a second plurality of magnets that are disposed along the edge portion of the magnetic cover so as to establish the airtight connection.

6. The system of claim 4, wherein the magnetic cover comprises a magnetic material configured to attach to the first plurality of magnets.

7. The system of claim 1, wherein the housing includes at least one depression configured to facilitate a practitioner using a hand to remove the magnetic cover from the housing.

8. The system of claim 7, wherein the at least one depression comprises a first depression and a second depression disposed near opposite sides of the magnetic cover.

9. The system of claim 1, wherein the magnetic cover comprises a rigid material that is sufficiently durable and temperature resistant to retain its configuration during installation and operation when coupled with the housing.

10. The system of claim 9, wherein the magnetic cover comprises an injection molded material and a plurality of magnets disposed along an edge portion of the magnetic cover so as to attach to a plurality of magnets disposed along an edge portion surrounding an opening to the interior of the housing.

11. The system of claim 10, wherein the magnetic cover comprises a metallic material that is capable of magnetically attaching to a plurality of magnets disposed along an edge portion surrounding the opening to the interior of the housing.

12. A method for an air filtration system for an internal combustion engine, the system comprising:
forming a housing comprising an air filter box having an interior configured to receive an air filter;
configuring a mount portion to support the air filter;
forming a magnetic cover to enclose the interior; and
disposing an inlet to allow an airstream to enter the interior.

13. The method of claim 12, wherein forming the housing includes configuring an opening to provide access to the air filter within the interior.

14. The method of claim 13, wherein configuring the opening includes configuring an edge portion surrounding the opening to form an airtight connection with an edge portion of the magnetic cover.

15. The method of claim 14, wherein configuring the edge portion includes disposing a first plurality of magnets along the edge portion to attach to a second plurality of magnets that are disposed along the edge portion of the magnetic cover so as to establish the airtight connection.

16. The method of claim 12, wherein forming the housing includes configuring at least one depression to facilitate a practitioner using a hand to remove the magnetic cover from the housing.

17. The method of claim 16, wherein configuring the at least one depression comprises disposing a first depression and a second depression near opposite sides of the magnetic cover.

18. The method of claim 12, wherein forming the magnetic cover comprises forming a rigid material that is sufficiently durable and temperature resistant to retain its configuration during installation and operation when coupled with the housing.

19. The method of claim 18, wherein forming the magnetic cover comprises injection molding a material into and disposing a plurality of magnets along an edge portion of the magnetic cover so as to attach to a plurality of magnets disposed along an edge portion surrounding an opening to the interior of the housing.

20. The method of claim 19, wherein forming the magnetic cover comprises fabricating a metallic material that is capable of magnetically attaching to a plurality of magnets disposed along an edge portion surrounding the opening to the interior of the housing.
